(19) United States
(12) Patent Application Publication
(10) Pub. No.: US 2012/0191421 A1
(43) Pub. Date: Jul. 26, 2012

(54) Oral Template for Integrated CT and Optical Images for Dental Implant Drilling Templates and Orthodontic Aligners

(75) Inventor: Alex M. GREENBERG, New York, NY (US)

(73) Assignee: Greenberg Surgical Technologies, LLC, New York, NY (US)

(21) Appl. No.: 13/299,269

(22) Filed: Nov. 17, 2011

Related U.S. Application Data
(60) Provisional application No. 61/414,764, filed on Nov. 17, 2010.

(51) Int. Cl. G06F 17/50

(52) U.S. Cl. 703/1

(57) ABSTRACT

A method for producing a virtual model of a patient includes placing a radiographic template in contact with a first surface of the patient. The radiographic template includes a plurality of radio-opaque markers and a shape of known dimensions. A negative impression of the first surface is formed by the radiographic template. A first CT scan of the radiographic template and said first surface is performed. The radiographic template is removed from the first surface. A second CT scan of the radiographic template apart from the first surface is performed. The first CT scan and said second CT scan are merged to produce an artifact-corrected image. An optical scan of the radiographic template including the negative impression is performed. The artifact-corrected image and the optical scan are merged based on the shape of known dimensions to produce a virtual model of said patient.

### RELATED APPLICATIONS

This application claims priority from U.S. Provisional Patent Application Ser. No. 61/414,764, which was filed on Nov. 17, 2010, the entire contents of which are incorporated herein by reference.

### FIELD OF THE INVENTION

The present invention relates to dental implant and orthodontic treatment planning and in particular to the creation of integrated CT and optical scan data for dental implant and orthodontic treatment planning and the production of dental models, surgical drill templates and orthodontic aligners.

### DESCRIPTION OF THE RELATED ART

CT scanned 3D images or virtual optically acquitted images of dentitions are conventionally registered to allow for treatment planning for the placement of dental implants and orthodontic treatment aligners. For example, U.S. Pat. Nos. 7,573,583 and 7,355,721 describe conventional imaging methods that relate to the well-known dental software E4D Compass. U.S. Pat. No. 6,319,006 relates to another conventional imaging method well-known in the dental field. U.S. Publication Nos. 2006/0291968 and 2009/0113714 by the present inventor, the entire contents of which are incorporated herein by reference, disclose drilling templates and orthodontic aligners formed from conventional imaging and treatment planning methods.

These conventional methods provide for the superimposition of CT scanned 3D or virtually optically acquired images of radiographic templates and dentitions on the basis of surface-to-surface superimposition. However, these conventional methods have limitations in that they require the bonding of a shape of known dimensions (SKD) on the dentition itself as in the method of U.S. Pat. No. 6,319,006 so that the dentition can be acquired by the CT scan for registration. Conventional methods are thus limited by the need to apply physical markers of standardized known dimensions and shape to the teeth themselves.

The merger of two data sets of digitized CT images involving the superimposition of a separate CT image of the radiographic template to CT bone images of the radiographic template in the patient's mouth also does not provide a sufficient level of detail and accuracy required for the production of some types of dental models, surgical drill templates and orthodontic aligners.

Furthermore, another limitation of conventional imaging methods is their dependence on surfaces of adjacent teeth for determining a dental implant trajectory.

### SUMMARY OF THE INVENTION

One objective of the present invention is to provide an improved method which permits the combined registration of fiducial markers and a shape of known dimensions (SKD), e.g., a Lego®, to provide for the registration of data of a CT scan and data of an optical scan as an improvement over conventional methods.

Another objective of the present invention is to from a template for use with an instrument to drill a hole at a location and/or for orthodontic movement of at least one tooth based on a virtual model created from the registration of data from a CT scan and data from an optical scan as an improvement over conventional methods.

Still another objective of the present invention is to avoid a reliance upon surfaces of adjacent teeth for determining a dental implant trajectory by utilizing a tooth form or dental bridge (fixed partial denture) form in coordination with underlying bony anatomy to determine the desired dental implant trajectory.

According to an example embodiment, a method for producing a virtual model of a patient includes placing a radiographic template in contact with a first surface of the patient. The radiographic template includes a plurality of radio-opaque markers and a shape of known dimensions. A negative impression of the first surface is formed by the radiographic template. A first CT scan of the radiographic template and said first surface is performed. The radiographic template is removed from the first surface. A second CT scan of the radiographic template apart from the first surface is performed. The first CT scan and said second CT scan are merged to produce an artifact-corrected image. An optical scan of the radiographic template including the negative impression is performed. The artifact-corrected image and the optical scan are merged based on the shape of known dimensions to produce a virtual model of said patient.

### BRIEF DESCRIPTION OF THE DRAWINGS

The invention will now be described in further detail with reference to the drawings in which:

FIG. 1 shows a radiographic template according to an example embodiment;

FIG. 2 shows a radiographic template according to another example embodiment;

FIG. 3 is a flow chart showing steps for producing a virtual model according to an example embodiment;

FIG. 4 is a flow chart showing steps for fabricating a template according to an example embodiment;

FIG. 5 shows a template for the insertion of an electrode through the greater palatine foramen of a patient according to an example embodiment;

FIGS. 6A through 6E illustrate the use of a radiographic template with a dental model for attachment of the dental model to a base plate of the radiographic template with a transfer of an identical position of a shape of known dimensions (SKD) to the baseplate according to an example embodiment;

FIG. 7 shows a radiographic template for taking an impression of the upper and lower arches of a patient in a single bite according to an example embodiment;

FIG. 8 is a flow chart showing a production sequence for producing a series of orthodontic aligners according to an example embodiment; and

FIG. 9 shows an example dental implant according to an example embodiment.

### DETAILED DESCRIPTION OF THE PRESENTLY PREFERRED EMBODIMENTS

Example embodiments of the present invention utilize processes disclosed in R. Jacobs et. al., “Predictability of a three dimensional planning system for oral implant surgery”, Dentomaxillofacial Rad., 1999, 28, pp. 105-111, and Van Steenberghe, “A custom template and definitive prosthesis”, Int. J. Maxillofacial Implants, 2002, 17, pp. 663-670, as well as processes in U.S. Pat. No. 7,574,025, the entire contents of which are incorporated herein by reference. U.S. Pat. No. 7,574,025 discloses the use of a dual scan process of a radiographic scan appliance or template with fiducial markers for performing a scan of a radiographic template in a patient's mouth and a separate scan of the radiographic template in a Styrofoam box, thus creating two data sets that allow for the creation of an artifact corrected image. The two data sets of digitized CT images are merged in planning software with registration and superimposition of the separate image of the radiographic template to the bone images of the radiographic template in the patient's mouth. Registration is a software process whereby the separate 3D digital image of the radiographic template alone is overlaid on the 3D digital image of the radiographic template in the patient's mouth so that their outlines match in spite of artifact distortion.

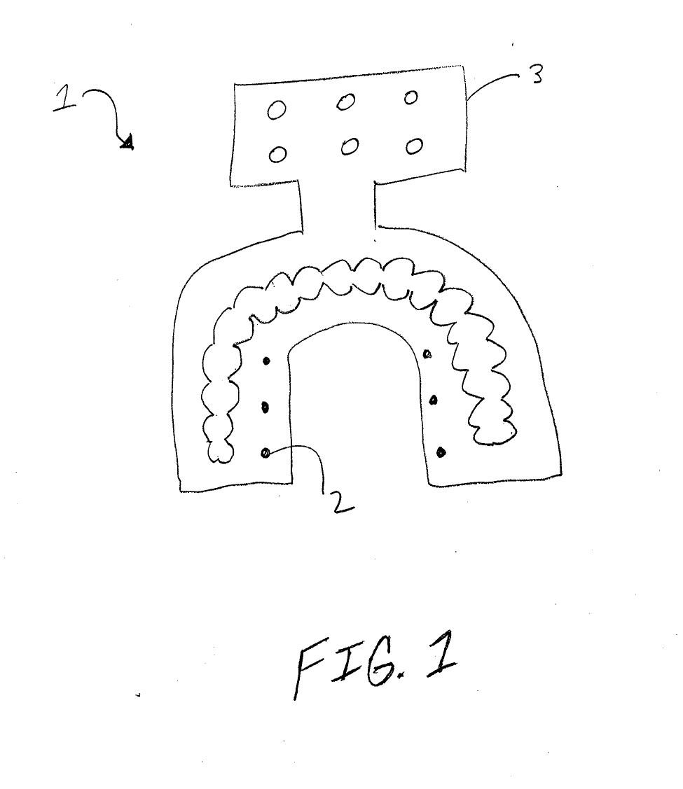

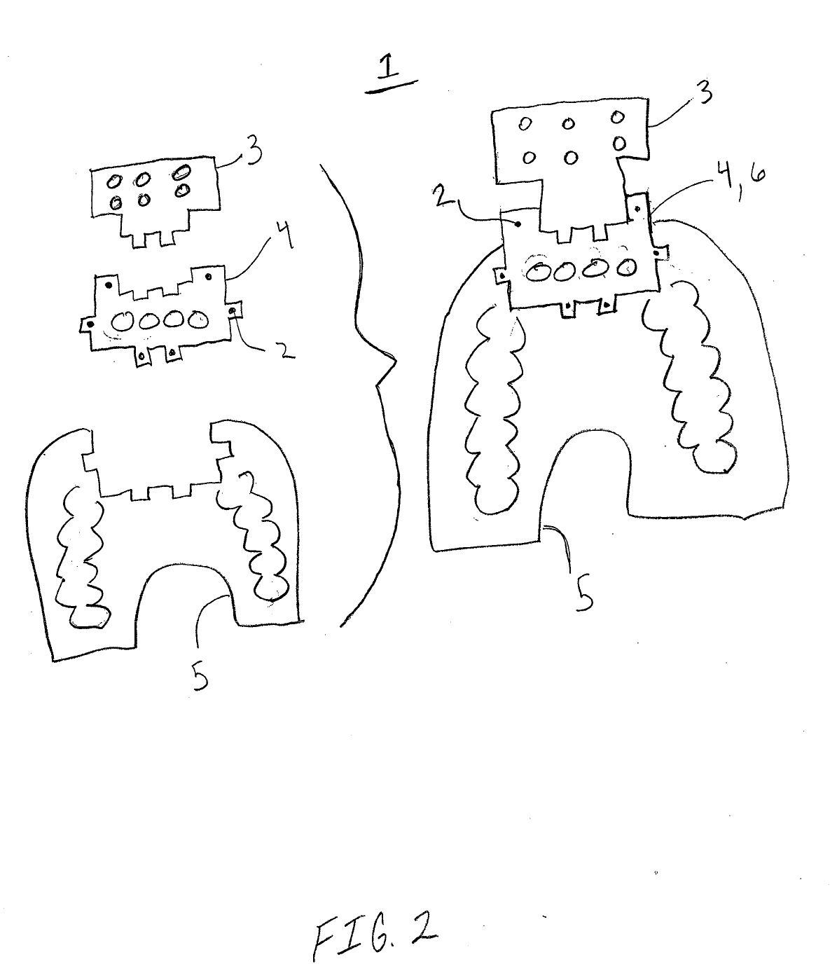

A radiographic template 1 according to an example embodiment comprises fiducial markers 2, which can be made of a radio-dense or radio-opaque material such as metal filings, gutta-percha etc., and a shape of known dimensions (SKD) 3, e.g. a Lego®. The radiographic template 1 can be a standardized template manufactured from an injection-molded material that comprises in a handle thereof the SKD 3, as shown in FIG. 1. The SKD 3 of the radiographic template 1 thus extends outside the lips of a patient when the radiographic template 1 is in the patient's mouth. The radiographic template 1 can alternatively have a modular form, as shown in FIG. 2 and described in more detail below. The SKD 3 can be either a positive or a negative impression depending upon the needs of the software manipulating data for the processing of digitized images in order to create the registration between a data set of a CT scan of the patient and radiographic template and a data set of a CT scan of the radiographic template alone, and a separate additional registration of an optical scan of a negative impression of the radiographic template 1 including the SKD 3.

The radiographic template 1 is configured to take a negative impression of a patient's teeth. The negative impression of the radiographic template 1 contains occlusal surfaces of the patient's teeth in a malleable material, e.g., dental acrylic, or the impression can be a negative impression of the teeth with a material, such as, a polyether or poly vinyl siloxane, applied to the radiographic template 1 which is used as a dental impression tray. The radiographic template 1 can be standardized in different sizes to accommodate different sized mouths, e.g., in small, medium, and large sizes.

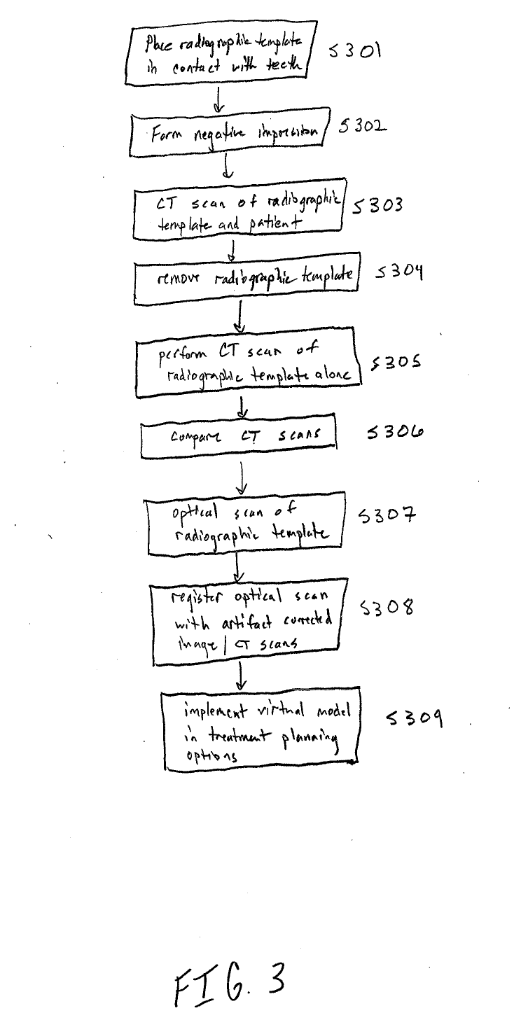

FIG. 3 is a flow chart showing a method for producing an artifact corrected image which includes the registration of data from a CT scan and data from an optical scan according to an example embodiment. The radiographic template 1 is placed in contact with the patient's teeth at S301. A negative impression of the patient's teeth is formed by said radiographic template 1 at S302. A CT scan of the patient, i.e., the patient's teeth, and radiographic template 1 is performed at S303. The radiographic template 1 is removed from the patient at S304. A CT scan of the radiographic template 1 alone, i.e., apart from the teeth of the patient, is performed at S305. Registration (comparison or merger) of the data sets of the two CT scans is performed at S306 to create an artifact corrected image. The registration may be based on the fiducial markers 2 in each of the CT scans such that the fiducial markers in the first scan are matched with the fiducial markers in the second scan in order to align the two CT scans. The registration, i.e., merger or comparison, of the two CT data sets provides an artifact corrected image to be superimposed over the bone image so that in the presence of dental restorations or fixed metal orthodontic appliances the radiographic template 1 can be segmented in a correct relationship to the anatomic bony structures. The artifact corrected image provides for the insertion of a post segmentation functional element such as a dental implant trajectory that can be transformed into a shape within the radiographic template clean artifact corrected image as drill trajectory channel that will be formed as a subtraction of material in the rapid prototyping/rapid printing of the digitally created surgical drill guide template as described in U.S. Pat. No. 7,574,025.

The radiographic template is optically scanned by either a hand held scanner, e.g., a Sirona CEREC, 3M Lava, D4D E4D, Densys, Cadent iTero, or a desk top scanner, e.g., a 3MLava, Straumann Etkon, D4D E4D, to create a virtual negative impression of the negative impression of the radiographic template 1 at S307. A .stl file of the optically scanned virtual model of the dentition is registered with the CT scan data of the registered patient data and radiographic template and the artifact corrected radiographic template through registration based on the SKD S308. That is, the registration of the optical scan with the CT scans may be based on the SKD in the optical scan and the SKD in the CT scans such that the SKD in the optical scan is aligned or matched with the SKD in the CT scans so that the optical scan can be merged with the CT scans. Accordingly, an artifact corrected image of the dentition can be represented in the combined CT and optical scans of the patient and radiographic template data which provide a virtual model that can be used in various treatment planning options and for the production of dental models, surgical drill templates and orthodontic aligners. The combined CT and optical scans of the patient and radiographic template data advantageously provides for the merger of micron level accurate data of the teeth from the optical scan with millimeter level accurate date of the bone from the CT scans. The integrated CT scan and optically scanned data image provides for a multitude of treatment planning options for a practitioner within a virtual environment that can allow a variety of outputs through rapid manufacturing/rapid printing/rapid prototyping and computer aided design/computer aided manufacturing (CAD/CAM) manufacturing methods. The multitude of outputs can be used for the fabrication of dental implant surgical guides, jaw fracture bone plating drill guides, medical applications, such as, electrode insertion for modulation of the Sphenopalatine/nasoplatine ganglion for vascular effects as disclosed in U.S. Pat. Nos. 7,120,489 and 7,729,759, and orthodontic appliances. The fabrication processes can also be performed in modular forms, as discussed in more detail below with respect to FIG. 2. The virtual planning environment can also provide for the virtual insertion of crowns, bridges, dental implant fixed and removable prostheses and their parts for the planning, fabrication, and insertion of dental prosthetics, dental implants, orthodontic aligners and any combination thereof for dental treatment.

Another embodiment of the present invention provides for the creation of dental models by stereolithography, rapid printing, and rapid prototyping methods. Dental models formed based on virtual models according to example embodiments have more accurate representations of the patient's teeth including undercuts as well as the dental anatomy of tooth roots. The representations of the tooth roots can be colored in a different color than the rest of the dental model. A series of dental models may be produced by rapid prototyping so as to create a series of orthodontic aligners for a series of planned tooth movements for the correction of various orthodontic malocclusions. This is an improvement over conventional methods utilized by Align Technologies based on U.S. Pat. Nos. 5,975,893, 6,699,037, 6,722,880 and U.S. Publication No. 2010/00167243, which create a CT scan of a dental cast using a CT industrial scanner. These conventional methods manipulate the CT image of the teeth and the undercuts to create stereolithographic models of each stage of the planned orthodontic tooth movement, and the individual stereolithographic models are then utilized to create dental aligners on an industrial scale production line. Example embodiments, however, obviate the need for a creating a dental cast that has to be separately CT scanned and instead use optical scan data of the digital impression, which is merged with the CT scan of the patient and radiographic template and the separate scan of the radiographic template as described above, to create a virtual model of the patient. The data of the virtual model of the patient is used to fabricate a series of dental aligners without the need for creating a dental cast. Furthermore, example embodiments incorporate the dental root anatomy from the CT scan into the virtual model and plan of the patient, which allows the planned series of orthodontic tooth movements to include the root anatomy including virtually modeled interactions of the root anatomy with bone structure and teeth. Accordingly, when the teeth are moved by software manipulation of the virtual model/image of the patient, the tooth movements, whether they are rotational, tipping, bodily movements in the correction of Class I, II, III tooth crowding, Class I, II, III overjet and overbite discrepancies, combinations of using cut outs in the aligners for Class II and III elastics, or orthodontic brackets for elastic traction, tooth attachments with particular shapes that promote rotation, extrusion, tipping, or bodily movements are considered and virtually modeled. Knowledge of root anatomy can also affect the desired velocity of movement and pattern of movement in order to avoid collision between roots in the process of tooth movement by the planned biomechanical movement of the aligners. It is well understood from dental anatomy studies and CT data concerning tooth roots that there is considerable variation in the pattern of tooth roots that cannot be estimated only by extrapolation from the longitudinal axis of teeth as taught by US Publication No. 2010/0167243. The incorporation of CT data allows more precise knowledge of tooth root anatomy into this type of removable aligner treatment for orthodontic malocclusion. The integration of the CT data and optical scan data of the tooth crown anatomy including the undercuts allows a more precise dental model to be created in which the teeth are represented by accuracy to within 100 microns or less in and the bone anatomy is represented by millimeter level accuracy in the virtual model. Accordingly, a superior aligner that incorporates the CT data of the root anatomy into the biomechanical model of planned orthodontic tooth movements can be fabricated based on the virtual model and planning. It is also possible that with the accumulation of a database of treated cases to create a database, from the virtual models of patients, of common root anatomy patterns that coincide with different anatomic tooth forms and classifications of dental malocclusion such as Class I, II and III. The creation of such a database also facilitates the ability to treat more surgical cases with aligners as there is a greater understanding of the complete dental anatomy and bony anatomy of the maxillomandibular dysplasia.

It is also possible that direct printing of aligners based on the virtual models can be achieved by using rapid printing, rapid prototyping technologies as a digital subtraction of the scanned radiographic appliance into the correct form of an aligner or the application of virtual material onto the dental model so as to create an aligner that is made of a malleable material with adequate flexibility to fit over the undercuts of teeth.

Orthodontic aligners fabricated according to example embodiments can also incorporate planning for dental implants and the creation of combined orthodontic aligners with a surgical drill guide template for the placement of dental implants based on the planned final orthodontic position of teeth and the planned location and trajectory of a dental implant. In the series of orthodontic aligner treatments it is also be possible to use the orthodontic aligner as a drill guide for the planned placement of Temporary Orthodontic Anchorage Devices (TADS) that may be part of elastic traction, hybrid aligner and fixed banded orthodontic treatment, and surgical cases where TADS of varying sizes can be used for surgical correction of dentofacial deformities/maxillomandibular dysplasia.

The integrated CT and optical data set is also useful for the creation of dental implant drilling templates that use the planned dental prosthesis as a guide for the planned trajectory of the dental implant as opposed to simply relying on the anatomy of the surfaces of adjacent teeth as in the U.S. Pat. No. 6,319,006. In this way a virtual model of the patient can be created in which the radiographic template will be converted into a surgical drilling template that can be created by either rapid manufacturing, rapid printing or CAD/CAM milling.

Further example embodiments of the present invention include various modular forms of manufacturing for combining optical scan data with CT scan data. For example, a modular radiographic template 1 as shown in FIG. 2 may be created in which the handle containing the SKD 3 interlocks by semiprecision attachment or other types of attachments to a modular part 4 including the fiducial markers 2 of the modular radiographic template 1, which is also interlocked via semiprecision attachments into radiographic template framework 5 to create the total radiographic template 1. The modular part 4 may be, for example, a temporary bridge prosthesis that has been CAD/CAM milled and is attached to the radiographic template framework 5 so as to incorporate a final temporary prosthesis and, by extension, a shape of the final prosthesis into the CT scan data so as to provide the correct prosthetic information for use in treatment planning of the dental implant trajectory or trajectories for the creation of a surgical drill template.

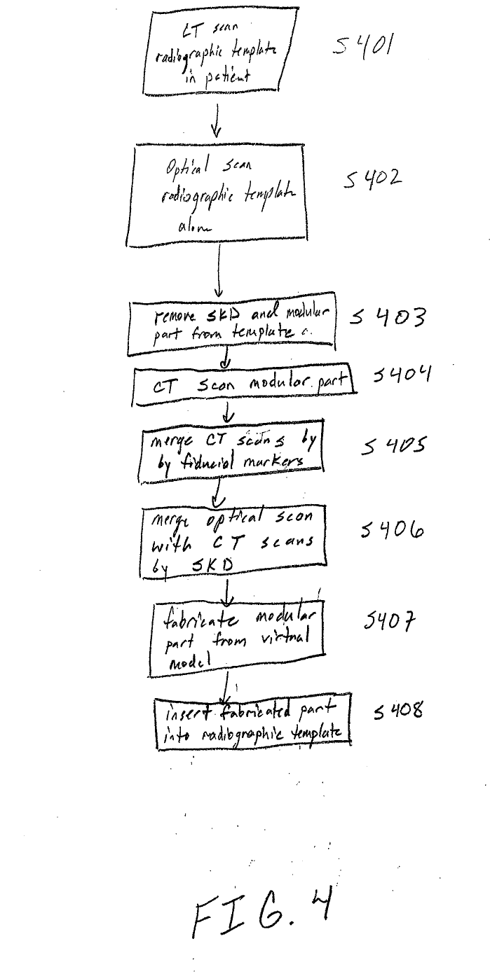

FIG. 4 is a flow chart showing a method for producing from a modular template an artifact corrected image which includes the registration of data from a CT scan and data from an optical scan according to an example embodiment. A CT scan is performed of the patient with the modular radiographic template 1 in the patient's mouth at S401. The modular radiographic template 1 can be made of a malleable material, such as, dental acrylic or a polyvinylsiloxane or polyether impression made with the radiographic template, which can be of a standardized form for different sized mouths e.g., small, medium, and large sizes. The radiographic template is removed from the patient, and an optical scan of the total modular radiographic template 1 is created using a desktop scanner or hand held scanner in a dentist's office or at a dental laboratory at S402. The interlocked SKD 3 and modular part 4 are removed from the total radiographic template 1 at S403, and the modular part 4 is CT scanned separately at S404. The CT scanned data sets of the patient and total radiographic template 1 and the modular part 4 alone are merged and registered based on the radiographic/fiducial markers 2 at S405, and a separate registration and merger of the optical scan data is created so as to create an integrated CT scan and optical scan virtual model of the patient based on the SKD 3 at S406. Planning for the dental implant trajectory is performed and a drill guide template modular part 6 is fabricated by rapid printing/rapid prototyping/CAD/CAM milling with insertion of drilling sleeves at S407 based on the virtual model, and inserted at back into radiographic template framework 5 in place of the modular part 4 at S408. If a polyvinylsiloxane or polyether impression material is utilized, the material can be removed for the insertion of the modular drill guide part 6 into the radiographic template framework 5 for clinical use. Alternatively, the optically scanned model may be merged with a virtual model of the planned temporary bridge obtained via virtual crown planning optical scan software systems, such as, hand held Lava, E4D, iTero, or desktop scanners, such as, Lava, Etkon, Everest, dental wings, to create a surgical drill template via rapid printing, rapid prototyping or CAD/CAM milling and having the accuracy of the fit of the occlusal surfaces from the optical scan of the impression and the CT scan data of the bony anatomy. Accordingly, a modular method of fabricating a surgical drill template can be achieved in a strictly virtual space with the fabrication of the surgical drill template. It is also possible that by utilizing an optical scan of the patient's dentition by a hand held scanner, a radiographic template in whole or modular form can be created for the CT scan and that same data set can be utilized through the integrated merger of the CT scan and optical scan data of the radiographic template to create a dental implant surgical drill template. The same data sets can also be integrated with a planned orthodontic aligner so that if there is a combined orthodontic treatment and dental implant treatment, coordination between these different treatment aspects of the patient can be planned by a single practitioner or communicated between different dental practitioners who may be generalists or specialists. Such planning could be further incorporated and integrated into dental practice management systems for the total management of such combined cases within a dental office or offices in coordination with dental laboratories.

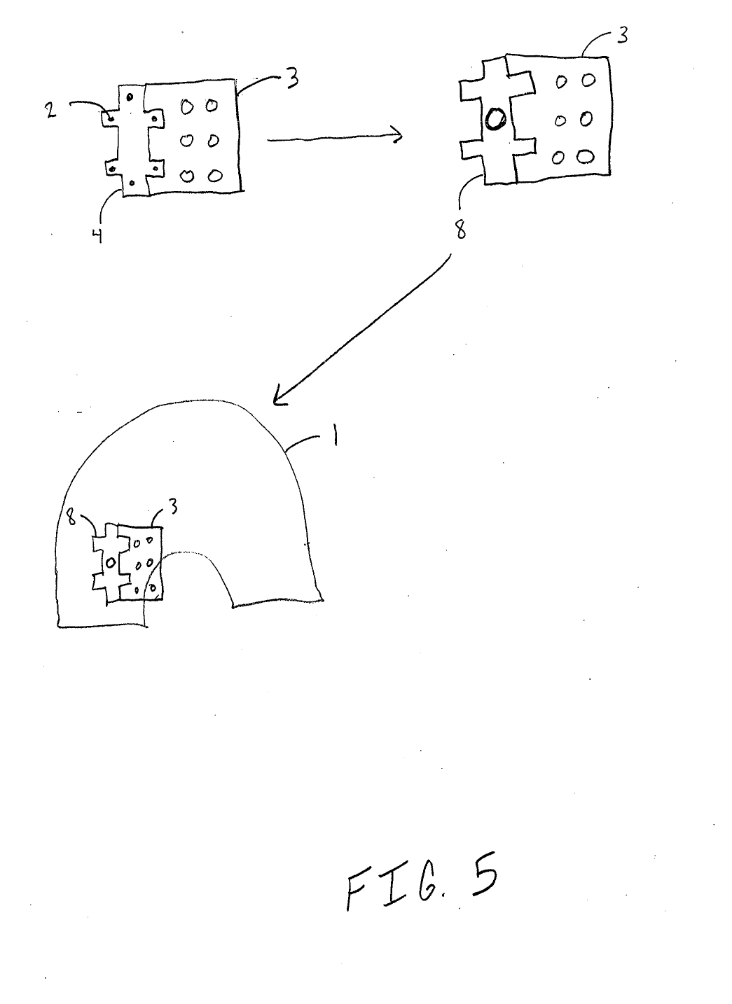

A further example embodiment of the present invention provides for the insertion of an electrode 8, as shown in FIG. 5, through the greater palatine foramen of a patient into the vicinity of the sphenopalatine gangion (SGG) also known as the nasopalatine ganglion (NPG) for the modulation of electrofrequency to cause vasodilation of the cerebral vasculature in patients suffering from stroke or dementia as disclosed U.S. Pat. Nos. 7,120,489, 7,729,759, 7,561,919, 7,640,062. The integration of the CT scan of the patient and radiographic template containing the SKD and the separate CT scan of the total template or the modular part of the template merged via registration of the optical scan of the radiographic template provides for the creation of a surgical template based on the virtual model for the insertion of the electrode via the greater palatine foramen. Accordingly, the electrode may be inserted into the patient without needing to surgically open the gum of the patient.

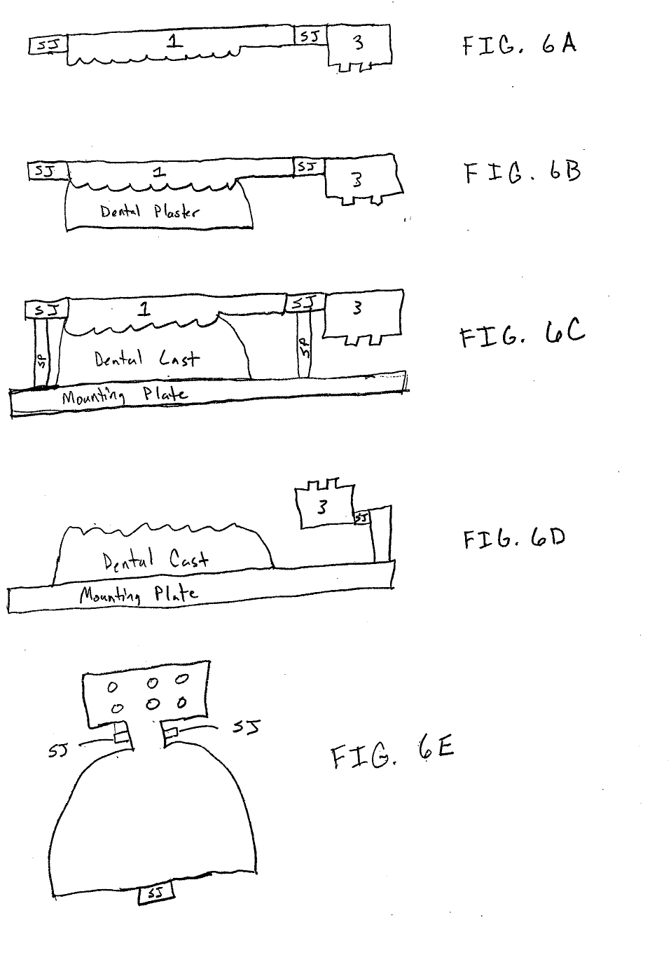

FIGS. 6A through 6E illustrate the use of a radiographic template 1 with a dental model for attachment of the dental model to a base plate of the radiographic template with the transfer of the identical position of the SKD to the baseplate so that a desktop scanner can be utilized to scan the dental cast for merger with the CT data set. FIG. 6A shows the radiographic template 1 with set joints SJ attached thereto for mounting the radiographic template 1. A CAD/CAM milled or dental plaster model is applied to the radiographic template 1, as shown in FIG. 6B. The radiographic template 1 is mounted on a mounted plate with set pins SP attached at the set joints SJ and to the mounting plate as shown is FIG. 6C. The dental cast and shape of known dimensions 3 are transferred to the mounting plate as shown in FIG. 6D, and the shape of known dimension is transferred to a SKD mount on the mounting plate such that the SKD is in the same position with respect to the teeth on the mounting place as when the negative impression was formed in the radiographic template 1. The radiographic appliance 1 has the SKD 3 attached via an attachment that allows the SKD handle to be detached and reattached to the base plate as it related exactly before to the dentition. The dental cast on the mounting plate is optically scanned, and the optically scanned data is registered with CT scanned data as described above with respect to example embodiments. Accordingly, the SKD 3 may be transferred in the exact position that it was in relation to the dentition. The dental model can thus be scanned if there is particular tooth anatomy that would preclude an accurate optical scan of the dental impression. This optical scan of the model can then be utilized to merge the dental model into the CT scan data, which incorporates processes from US Publication No. 2009/0113714.

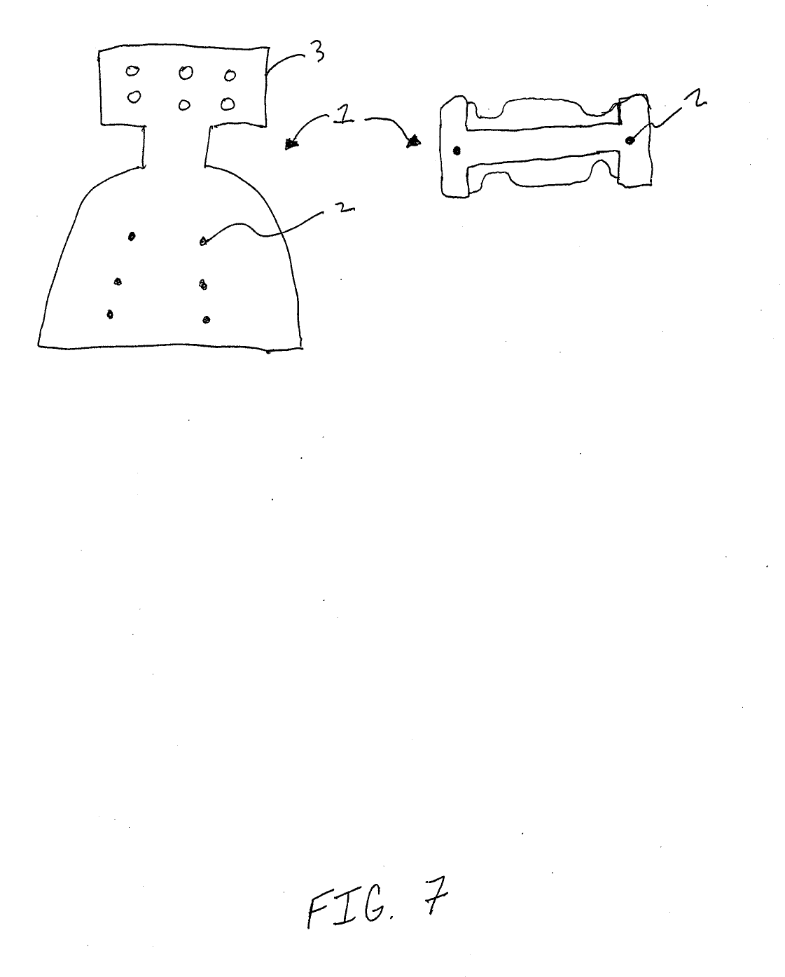

FIG. 7 shows a radiographic template 1 for taking an impression of the upper and lower arches of a patient in a single bite. Radiographic templates according to example embodiments may be incorporated in a two part process involving the upper and lower jaw arches of a patient to incorporate CT data of the tooth roots in order to create information on the opposing arches in the CT scan data base as disclosed in U.S. Pat. No. 5,975,893, the entire contents of which are incorporated herein by reference. A radiographic template 1 comprising an impression tray that contains polyvinylsiloxane is used to take impressions of each of the upper and lower arches of a patient in a single bite. Radiographic or fiducial markers 2 are placed in the impression tray so that registration of the CT scanned data sets can be performed. A SKD 3 is attached to the handle of the tray so that there is a SKD facing each impression. Therefore, there are two portions of the SKD 3 or separate SKDs 3 on opposing sides of the handle. The dual bite impression tray is CT scanned in the patient's mouth to obtain a first data set. The dual bite impression tray is removed from the patient, placed in a Styrofoam box and scanned in the CT scanner to obtain a second data set. The second data set of the dual impression radiographic guide data set is then registered with first data of the CT scan data of the patient and radiographic guide. Optical scans of each negative impression in the dual bite impression tray are obtained and registered with the CT data set via the respective SKDs 3. Merger of the optical and CT data sets is performed to create a virtual model or models including both the upper and lower arches of the patient. Articulation of the upper and lower arches in the virtual dental model or models is performed and compared to clinical photos submitted by the dentist. Planning of orthodontic movements is performed using the treatment planning software and a series of virtual dental models including the upper and lower arches is created for each stage of orthodontic movement. The planning includes information about the tooth roots in the planning of the orthodontic tooth movements, which improves planning of the forces used for moving each tooth, e.g., rotation, tipping, or bodily movements of each tooth based on known orthodontic biomechanical principles and at a certain velocity over time. Information concerning tooth roots helps to avoid collisions between tooth roots during movements of the teeth in orthodontic treatment and collisions between tooth roots and bone or tooth structures. Furthermore, if a method according to example embodiments is widely utilized and a large number of cases have been performed, information concerning the relationship of crown form to root form and their association with certain case types can be used to aid in the planning and creation of a series of aligners.

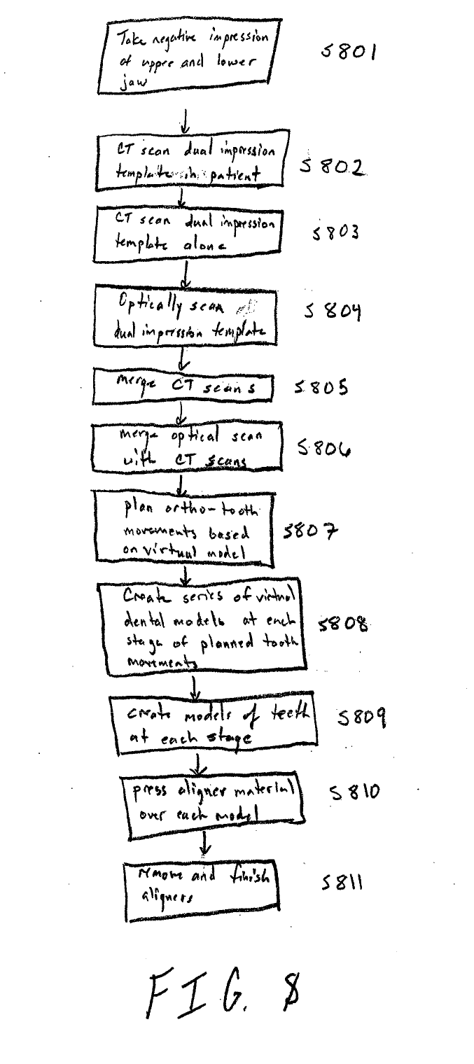

FIG. 8 illustrates a production sequence for producing a series of orthodontic aligners according to an example embodiment. An impression of a patient with an upper and lower jaw impression tray that has embedded radiographic markers and a SKD 3 as shown in FIG. 7 is taken at S801. A CT scan of the dual impression template and the upper and lower arches is performed at S802. A CT scan of the dual impression template apart from the upper and lower arches is performed at S803. An optical scan of the negative impressions in the dual impression template and SKD 3 is performed at S804. The data set of the CT scan of the patient and radiographic template is merged with the data set of the CT scan of the radiographic template at S805. If individual scans of each arch with a radiographic appliance are made, different SKD can be applied to each arch so as to allow merger of the different radiographic appliances with the optical scan of each negative impression. The CT scanned data sets and the optically scanned data set are registered and merged to create a virtual dental model with associated root anatomy at S806. Planning of orthodontic tooth movements based on the virtual dental model is performed at S807. Gingiva or gums may be segmented out from the virtual dental model for the orthodontic tooth movement planning and applied when the series of models are created so that an anatomically correct aligner is created. A series of virtual dental models at each stage of the planned orthodontic tooth movement are created at S808. The series may include various hybrid elements, such as, elastic traction, TADs, and the presence of orthodontic attachments for specific tooth movements and elastic traction, and attachments for retention. The retention attachments may also include radiographic/fiducial markers and a SKD for initial/repeat CT scanning and optical scanning of the dentition for registration and merger of data. Other designs within the virtual dental model can be added that will create other biomechanical forces in the aligner. Dental implant planning can incorporated into the orthodontic tooth movement planning as well as any planning for dental prosthetics for natural or implant teeth. After planning and virtual modeling is complete, stereolithographic or rapid printed/rapid prototyped models of the teeth are created at S809. Laser or other identification tags are placed on each model in sequence of aligner treatment. The stereolithographic models are mounted on carriers on an assembly line. The carriers may be located on the assembly line by RFID tags. Webs of thermoplastic material are pressed over each stereolithographic model and the aligners are created at S810. The aligner material hardens and is trimmed by robotic CAD/CAM milling to create the correct contours, and additional cut-outs may be created as specified in the dentist's prescription. Other grooves and contours can be milled in as well so as to create additional orthodontic biomechanical forces. The aligners are removed from the models, polished and sorted by sequence of treatments, and packaged according to prescription sequence and case for shipping to the dentist at S811. Alternatively, the aligners can be created virtually according to the sequence of planned orthodontic tooth movement and be fabricated by rapid printing technology using suitable polymers that are suitable for long-term presence in the oral cavity.

Another example embodiment provides for the creation of a virtual dental model as described above using the CT scan of the patient and a dual aligner or single aligners, a separate scan of the radiographic appliance(s), and merger via registration of the scan appliance for the placement of orthodontic brackets for a fixed orthodontic treatment. The planning software is used to plan the orthodontic treatment and to determine what the final position of the teeth will be and what the associated final orthodontic bracket position should be on each tooth so that brackets are located on the stereolithographic model and an aligner is created that will pick up the orthodontic brackets so that the aligner or appliance cements the orthodontic brackets on the teeth by an indirect technique, for example, as disclosed by U.S. Pat. Nos. 6,976,840 and 7,726,968.

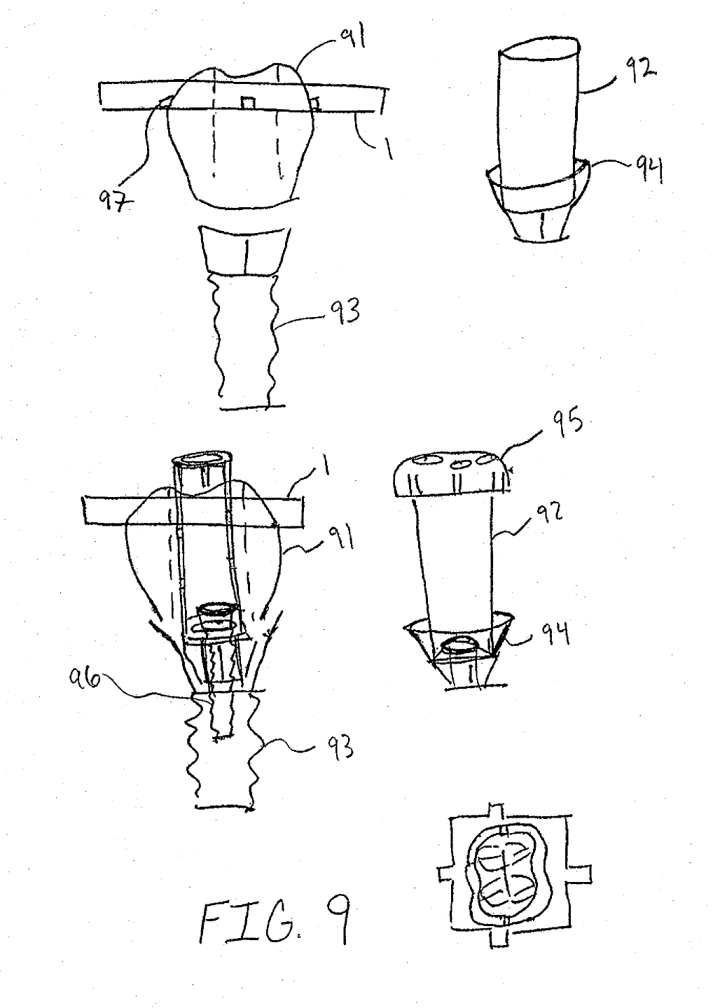

A further example embodiment is directed to a modular method of creating a CAD/CAM milled crown to be inserted onto the dental implant if the bone is less dense type II or III bone that may not allow the planned dental implant final position to be planned as precisely. FIG. 9 shows an example dental implant according to an example embodiment. A modular surgical drill template may be used for the insertion of a temporary CAD/CAM milled crown 91 with a post on a dental implant 93. As the implant is inserted into the bone, e.g., using a method disclosed in US Publication No. 2006/0291968, which is incorporated herein by reference in its entirety, in a modular method with a modular fabricated drill guide, it may be necessary to turn the implant 93 several turns deeper into the bone so that the implant 93 finally engages and locks into a final position in the bone, which precludes the placement of the CAD/CAM milled crown 91 at the time of dental implant placement. An alternative is to have a CAD/CAM milled crown 91 that will have an opening in the center that accommodates a prefabricated post 92, which can be straight or angled. The post comprises a widened base that extends into a cup 94 form so that when the CAD/CAM milled crown 91 is inserted onto the post 92, it will be attached by resin that is either cold or light cured. The cup 94 catches any flowing resin and prevents the resin from getting into the bone or under the soft tissue or an undesirable aspect of the base of the post 92. The post 92 may have a cap with a Biomet 3i Encode or Straumann Scan Body type of surface attached, which may be a snap-on that allows either an optical scan or traditional impression so that the data or model can be sent to a dental implant company such as Biomet 3i to scan the model and create a custom final post and crown which is inserted after a period of healing. The cup 94 of the post 92 that catches the flowing resin may be trimmed to create a correctly contoured temporary crown. A screw 96 attaches the dental implant 93 to the post 92. The radiographic template 1 is attached to the crown 91 by supports 97. The modular drill template may also act as a jig if the CAD/CAM milled temporary crown has interlocking attachments that fit into the modular drill template framework and allow the modular drill template gateway to act as a jig for the crown so that the crown is placed in the planned and correct position to the post. Once the crown is placed, the cap 95 may also be placed, and another optical scan or traditional impression that relates the final dental implant position to the planned final CAD/CAM milled abutment or the crown may be obtained.

A virtually integrated CT and optical scan model that contains accurate representation of tooth anatomy integrated with root anatomy and bony anatomy according to example embodiments can be further utilized for fixed appliance orthodontic treatment by creating aligners from the radiographic template image or by a manufacturing process in which a 3D model is fabricated by rapid prototyping, such as, stereolithography, in which an aligner of a malleable material is created on top of the 3D model. The 3D model is put through a simulation process of tooth movement to simulate the orthodontic tooth movement to final tooth positions with knowledge of the tooth crown shape and orientation as well as the tooth root anatomy and relationship to other tooth roots and adjacent bony and anatomic anatomy such as nerves and sinus cavities. The original model thus has ideal orthodontic brackets aligned on the teeth in the most ideal positions for the planned orthodontic treatment. The fixed orthodontic brackets are attached to the sterolithographic model by an adhesive so that a malleable aligner can be created on top thereof to fixate the orthodontic brackets, and upon removal an aligner containing the orthodontic brackets is created. The malleable aligner comprises a material of sufficient elasticity to hold the brackets, but is also able to release the brackets through an indirect application method. Adhesive composite is applied to the tooth side of the orthodontic fixed bracket, and acid etching and adhesive primer is applied to the teeth. The malleable aligner is then placed in the oral cavity on the dentition and, upon hardening of the composite adhesive, the fixed orthodontic brackets are adhered to the teeth in the desired position as planned by the software using the integrated optical and CT data. Orthodontic wires are then placed on the orthodontic brackets and fixed appliance orthodontic treatment begins. Accordingly, the treatment planning and models contain the information for orthodontic treatment which is improved from the knowledge of the root anatomy. This method can also be combined with a removable aligner treatment, such as, Invisalign®, in a combined aligner and fixed orthodontic treatment method as an improvement based upon the integrated CT optical model.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for producing a virtual model of a patient, comprising:
placing a radiographic template in contact with a first surface of said patient, the radiographic template comprising a plurality of radio-opaque markers and a shape of known dimensions;
forming a negative impression of said first surface by said radiographic template;
performing a first CT scan of said radiographic template and said first surface;
removing said radiographic template from said first surface;
performing a second CT scan of said radiographic template apart from said first surface;
merging said first CT scan and said second CT scan based on said plurality of radio-opaque markers to produce an artifact-corrected image;
performing an optical scan of said radiographic template including said negative impression; and
merging said artifact-corrected image and said optical scan based on said shape of known dimensions to produce the virtual model of said patient.

2. The method of claim 1, further comprising aligning the shape of known dimensions in the artifact-corrected image with the shape of known dimensions in the optical scan to merge said artifact-corrected image and said optical scan.

3. The method of claim 2, wherein said first surface is a jaw of the patient.

4. The method of claim 3, wherein the shape of known dimensions extends outside the lips of the patient if the radiographic template is in the patient's mouth.

5. The method of claim 3, wherein said virtual model of the patient includes representations of the dental root anatomy of the jaw of the patient and the teeth of the patient including undercuts of the teeth.

6. The method of claim 1, further comprising:
placing the radiographic template in contact with a second surface of the patient;
forming a negative impression of said second surface by said radiographic template; and
removing said radiographic template from said second surface, wherein said second CT scan of said radiographic template apart is performed apart from said second surface.

7. The method of claim 6, wherein said first surface is an upper arch of a jaw of the patient and said second surface is a lower arch of the jaw of the patient, and wherein articulation of the upper and lower arches is represented in the virtual model.

8. The method of claim 1, wherein said first surface is a jaw of the patient, and said method further comprises forming a template for orthodontic movement of at least one tooth of said patient based on said virtual model.

9. The method of claim 8, further comprising determining a planned final orthodontic position of the at least one tooth based on said virtual model.

10. The method of claim 9, wherein said virtual model of the patient includes representations of the dental root anatomy of the patient and the at least one tooth of the patient including undercuts of the tooth, and wherein said template for orthodontic movement is formed based on a modeled movement of the dental root anatomy and the at least one tooth of the patient to the planned final orthodontic position in the virtual model.

11. The method of claim 9, further comprising forming a surgical drill guide template for placement of a dental implant in combination with said template for orthodontic movement based on the planned final orthodontic position of the at least one tooth.

12. The method of claim 1, further comprising:
forming a template for use with an instrument to drill a hole at a location on said first surface based on said virtual model of said patient.

13. The method of claim 1, wherein said radiographic template comprises said shape of known dimension and a radiographic template framework, and said shape of known dimensions is detachably connected to said radiographic template framework.

14. The method of claim 13, further comprising:
forming a final part based on said virtual model of said patient;
removing said shape of known dimensions from said radiographic template; and
inserting said final part in the radiographic template.

15. The method of claim 1, further comprising:
forming a surgical template for the insertion of an electrode via the greater palatine foramen of the patient based on said virtual model.

16. The method of claim 1, wherein said first surface is a jaw of the patient, and said method further comprises:
planning orthodontic tooth movements of the patient based on the virtual model;
creating a series of virtual dental models at each stage of the planned orthodontic tooth movements; and
creating models of the teeth of the patient at each stage of the planned orthodontic tooth movements from the series of virtual dental models;
pressing thermoplastic material over each model of the teeth to create a series of dental aligners.

17. The method of claim 3, wherein the first and second CT scans provide data to the virtual model for representation of the dental root anatomy of the jaw of the patient, and wherein said optical scan provides data to the virtual model for representation of the teeth of the patient including undercuts of the teeth.

18. The method of claim 1, wherein said first surface is a jaw of the patient, and said method further comprises forming a surgical template for surgical movement of the jaw of said patient based on said virtual model for positioning the jaw at a final planned position during surgical reconstruction.

19. The method of claim 1, further comprising:
generating data representing a positive impression of said first surface from at least said second CT scan of said radiographic template apart from said first surface and including said negative impression.

20. A method for producing a virtual model of a patient, comprising:
placing a radiographic template in contact with a first surface of said patient, the radiographic template comprising a plurality of radio-opaque markers and a shape of known dimensions;
forming a negative impression of said first surface by said radiographic template;
performing a first CT scan of said radiographic template and said first surface;
removing said radiographic template from said first surface;
performing a second CT scan of said radiographic template apart from said first surface;
merging said first CT scan and said second CT scan based on said plurality of radio-opaque markers to produce an artifact-corrected image;
applying a CAD/CAM milled or dental plaster model to the radiographic template to form a dental cast of the negative impression;
transferring the dental cast and the shape of known dimensions to a mounting plate;
performing an optical scan of said dental cast and said shape of known dimensions transferred to the mounting plate; and
merging said artifact-corrected image and said optical scan based on said shape of known dimensions to produce the virtual model of said patient.
